(19) United States
(12) Patent Application Publication
(10) Pub. No.: US 2015/0199715 A1
(43) Pub. Date: Jul. 16, 2015

(54) SYSTEM AND METHOD FOR RECOMMENDING ITEMS IN A SOCIAL NETWORK

(71) Applicant: THOMSON LICENSING, Issy de Moulineaux (FR)

(72) Inventors: Stephane Caron, Paris (FR); Branislav Kveton, San Jose, CA (US); Marc LeLarge, Paris (FR); Smriti Bhagat, San Francisco, CA (US)

(21) Appl. No.: 14/411,856

(22) PCT Filed: Jun. 27, 2013
(86) PCT No.: PCT/IB2013/001641

§ 371 Date: Dec. 29, 2014

Related U.S. Application Data
(60) Provisional application No. 61/666,351, filed on Jun. 29, 2012.

(51) Int. Cl. G06Q 30/02; G06Q 50/00

(52) U.S. Cl. CPC G06Q 30/0254; G06Q 50/01

(57) ABSTRACT

The present principles consider stochastic bandits with side observations, a model that accounts for both the exploration/exploitation dilemma and relationships between arms. In this setting, after pulling an arm i, the decision maker also observes the rewards for some other actions related to i. The present principles provide a method and a system for efficiently leveraging additional information based on the responses provided by other users connected to the user via a computerized social network and derive new bounds improving on standard regret guarantees. We will see that this model is suited to content recommendation in social networks, where users' reactions may be endorsed or not by their friends.

### CROSS-REFERENCE TO RELATED APPLICATIONS

This application claims the benefit of U.S. Provisional Application Ser. No. 61/666,351, filed Jun. 29, 2012, which is incorporated by reference herein in its entirety.

### FIELD OF THE INVENTION

The present invention relates to computer-generated recommendations. Specifically, the invention relates to the provision of computer-generated recommendations in social networks using a model based on stochastic bandits with side observations.

### BACKGROUND

Systems and methods for targeting recommendations and advertising in interactive systems are known. Content providers and advertisers typically want to know how viewers perceive content and recommendations. For example, before embarking on the production and widespread distribution of one or more advertisements, advertisers often engage in various forms of test marketing to gain user response. In addition, content providers and advertisers also survey their target audience on an ongoing basis to determine the continued effectiveness of their advertisements, or recommendations.

One problem is how to provide a recommendation that matches best the interests of the user based on feedback they give.

### SUMMARY OF THE INVENTION

The present invention provides a method for recommending items such as movies, books, coupons for merchandise, or the like to a user or a group of users so that the recommendations are optimally provided to the user or group of users. Optimal, for example, in the sense that the target user is likely to purchase or use the recommended item. In particular, the present invention determines the target user or users by using feedback received from the direct user as well as users connected to the direct user in a social network, the information associated with users connected to the direct user in a social network is referred to as side information. In this manner, the system and method according to the present invention is able to more quickly and efficiently determine the desired target users by using the side information.

The multi-arm bandit mathematical approach is used in the invention to address the above-referenced issues with respect to providing recommendations. The mathematical theory of multi-arm bandits is extensive, with myriad versions studied from many arms, to delays, dependence among the arms, and so on. The present invention uses the multi-arm bandit approach modified with the use of side information, that is, information associated with other users, or friends, connected to the user in a social network.

In an embodiment of the invention, within a social network of users, a user is presented with content or item, for example a coupon for a movie, or the like. The user watches the movie and shares his opinion on whether he like the movie or not with friends connected to him within the social network. The friends connected to the user may then provide their respective comments and opinions on the movie. According to the present invention, the content provider learns the opinion of the user and the opinions of the friends connected to the user. Therefore, within the social network, the content provider is able to learn the opinion of a group of users with the cost of one discount coupon.

Now, considering the entire system, the content provider would like to give out the least number of coupons to determine the set of users that it should target for promoting movies from a given genre, e.g., comedy movies. The present invention provides a system and a method that leverages side observations in stochastic bandits to enable a content provider to more quickly and efficiently learn the distribution over a large number of users so that the content provider is able to optimally select the “best” users to promote a movie, or the like.

The foregoing description of the invention is better understood when read in conjunction with the accompanying drawings, which are included by way of example, and not by way of limitation with regard to the claimed invention.

### BRIEF DESCRIPTION OF THE FIGURES

FIG. 1 illustrates an embodiment having multiple user devices connected within a social network, which is able to receive recommendations;

FIG. 2 illustrates an exemplary embodiment of a flowchart showing the steps utilized according to the present invention;

FIG. 3 illustrates an embodiment using cloud-based resources to house the recommendation engine according to aspects of the invention;

FIG. 4 illustrates an example user device according to aspects of the invention;

FIG. 5 illustrates an example recommendation engine according to aspects of the invention;

FIGS. 6A-C illustrate per step regret of four bandit policies on the Flixster graph for various cover and clique combinations;

FIGS. 7A-C illustrate four per-step regret of four bandit policies on the Flixster graph with friend-of-friend side observations;

FIGS. 8A-C illustrate Per-Step regret of four bandit policies on the Facebook graph; and

FIGS. 9A-C illustrate per-step regret of four bandit policies on the Facebook graph with friend-of-friend side observations.

### DETAILED DESCRIPTION

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

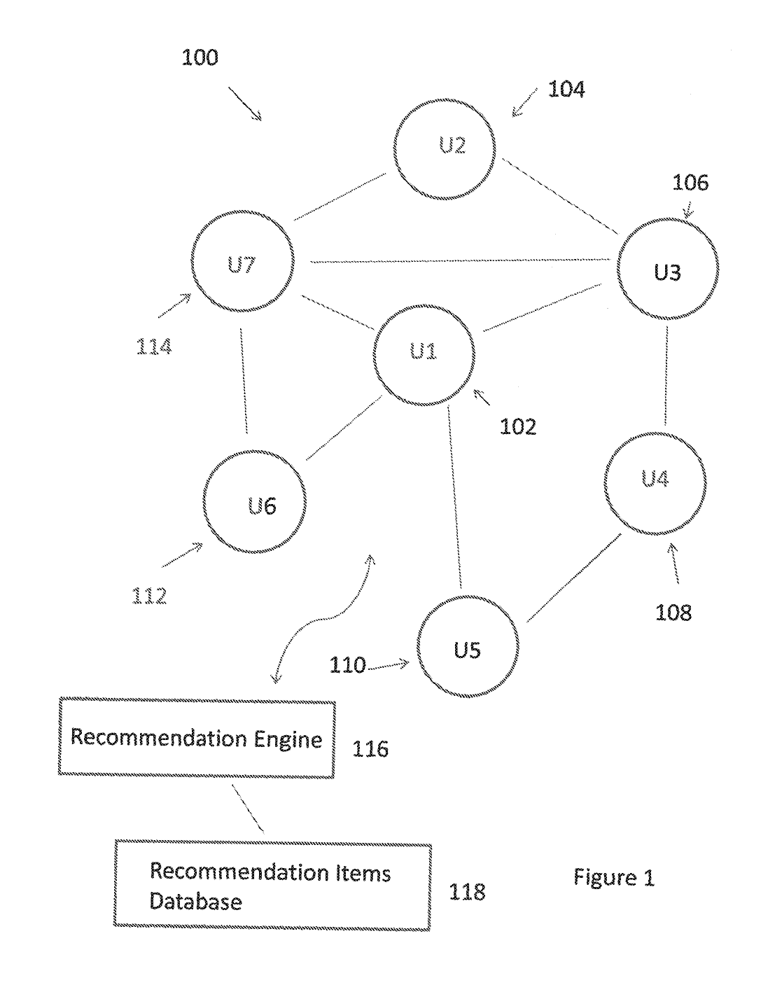

FIG. 1 illustrates an embodiment 100 of the invention comprising a plurality of users U1-7 that are connected via a social network. The users are connected to a recommendation engine 116, which provides recommendation items to selected ones of the users. The recommendation engine is connected to the users U1-7 via known network arrangements, including via the internet. The recommendation engine is also connected to a recommendation items database 118. The recommendation engine and database may be disposed in a content provider service. According to the present invention, the recommendation engine can provide recommendation to one or more users using the multi armed bandit with side observations technique as described herein.

Data on the users and groups may be stored in separate caches (not shown) within or remotely to the recommendation engine such that the engine 110 can support multiple groups. Users U1-7 may be embodied in any form of user device. For example, the User interface devices may be smart phones, personal digital assistants, display devices, laptop computers, tablet computers, computer terminals, or any other wired or wireless devices that can provide a user interface. Recommendation Items database 120 contains one or more databases of items that can be used as recommendations. For example, if a user or group of users, is to receive a movie recommendation, then items database 120 would contain at least many movie titles. As an aspect of the invention, user feedback on recommendations provided by the engine 110 is desirable. Thus, the interface devices associated with users U1-7 may be used for that purpose. In another embodiment the system 100 of FIG. 1 may be used as a basic architecture to serve multiple groups.

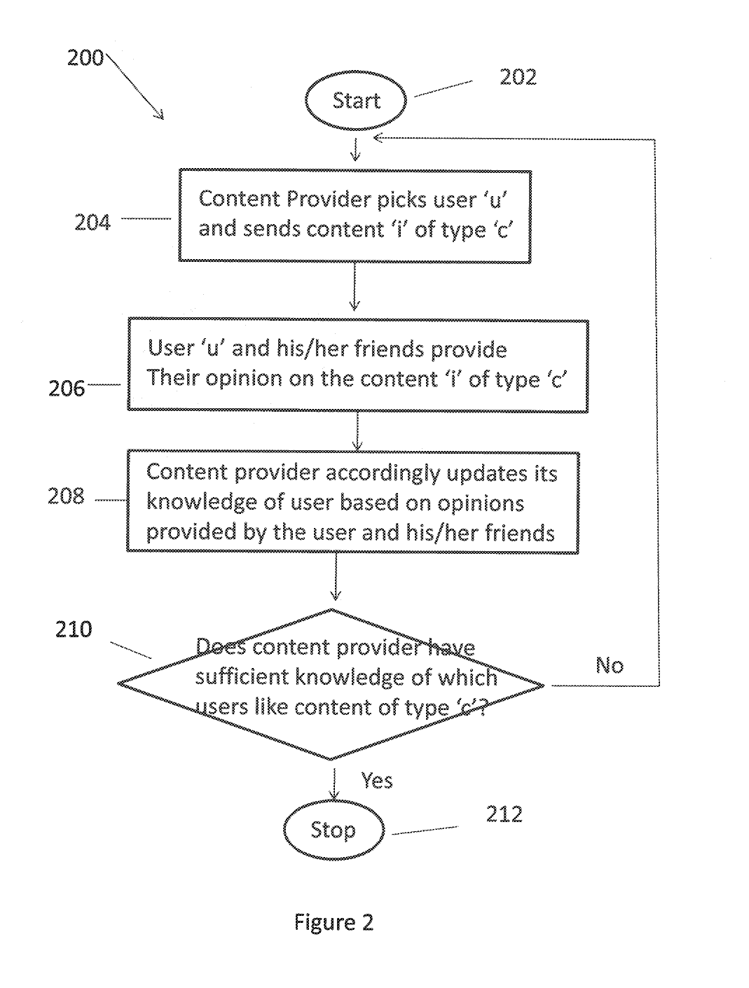

FIG. 2 is a flowchart illustrating steps associated with the present invention. At step 204, the content provider picks a user ‘u’ and send content or item recommendation ‘i’ of type ‘c.’ Upon receiving the recommendation and consumption of the content by the user, the user provides comment or opinion about the content or item to his/her friends connected via a social network. Along with the user's posting, his/her friends also provide their opinions on the content in step 206. At step 208, the content provider accordingly updates its knowledge of the user based on the opinions provided by the user and his/her friends. Additionally the content provider learns knowledge of the user's connected friends and updates accordingly. At step 210, the content provider determines whether it has sufficient knowledge of which users like the content of type ‘c’ based on the opinions evaluated, and send recommendations accordingly. The specific algorithms based on the stochastic bandit with side observations that may be used to implement the steps according to the invention are described in the additional description attached hereto in a paper entitled “Leveraging Side Observations in Stochastic Bandits.” Although FIG. 2 is illustrated with a stop step 212, it is to be understood that the methodology in accordance with the present principles may be an iterative process, which may be continuously repeated as the offers are provided to the users and the information about the users are updated. Continuously repeating the steps of the process considers a trade off between the exploration and exploitation to enable the system to learn quickly and efficiently.

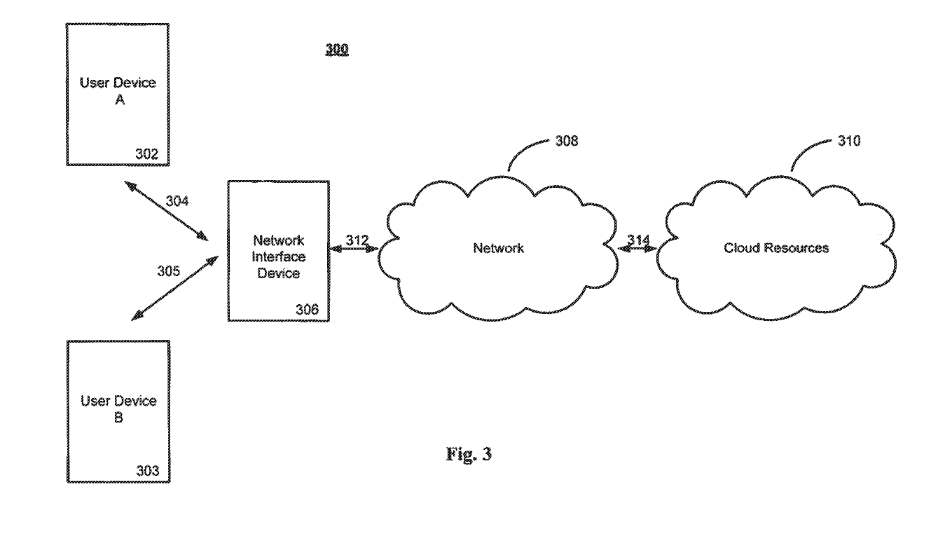

FIG. 3 depicts an embodiment of the invention which utilizes cloud resources to implement the recommendation engine. In the FIG. 3 system 300, a user device 302 or 303, such as a remote control, cell phone, PDA, laptop computer, tablet computer, or the like, may be used to access the network 308 via the network interface device 306. A user uses the user device to connect to other users via a social network. The network interface device may be a wireless router, modem, network interface adapter, or other interface allowing user devices to access a network. The network 308 may be any private or public network. Examples can be a cellular network, an Intranet, an Internet, a WiFi network, a cable network of a content provider, or any other wired or wireless network including the appropriate interfaces to the network interface device 306 and the cloud resources 310. The cloud resources 310 allow the user devices 302, 305 to access, via the network 308, resources such as servers that can provide the functionality required of a recommendation engine via the concept of cloud computing. The cloud resources 310 may also provide the recommendation items database that a content provider would supply to support the recommendations that the recommendation engine in the cloud resources would need. In another variation, the recommendation item database could be part of the network 308, which may be the network that a content provider supports.

Cloud computing is the delivery of computing as a service rather than a product, whereby shared resources, software, and information are provided to computers and other devices as a utility (like the electricity grid) over a network (typically, but not limited to the Internet). Cloud computing provides computation, software applications, data access, data management and storage resources without requiring cloud users to know the location and other details of the computing infrastructure. End users can access cloud based applications through a web browser or a light weight desktop or mobile app on their user devices while the business software and data are stored on servers at a remote location available via the cloud's resources. Cloud application providers strive to give the same or better service and performance as if the software programs were installed locally on end-user computers.

In another variation of FIG. 3, the network 308 and the cloud resources can be merged such that the combined network 308 and cloud resources 310 essentially provides all of the resources, including servers that provide the recommendation engine functionality and the recommendation item database storage and access.

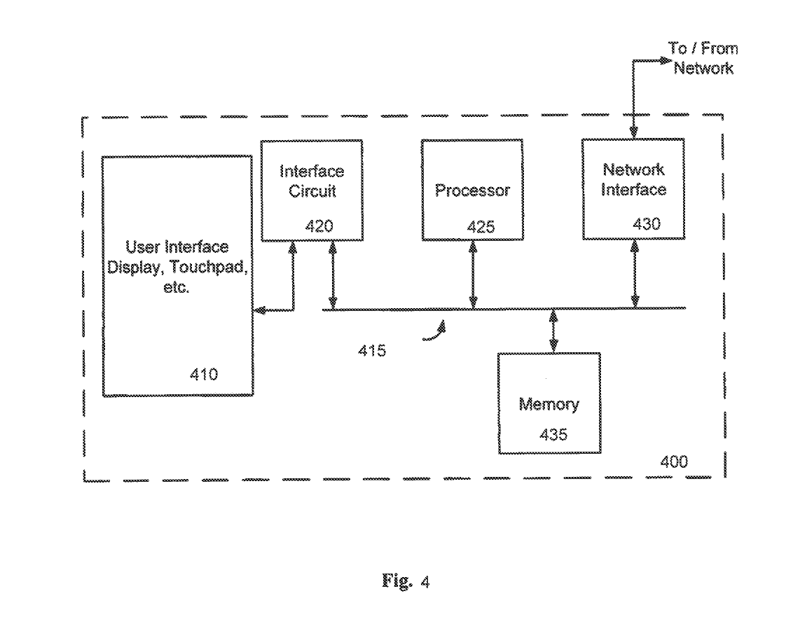

FIG. 4 depicts one type of user interface device 400 such as user interface device A 102 of FIG. 1. This type of user interface device can be a remote control, a laptop or table PC, a PDA, a cell phone, or a standard personal computer or the like. This device may typically contain a user interface portion 410, such as a display, touchpad, touch screen, menu buttons, or the like for a user to conduct the steps of individual and group user data entry as well as reception of recommendations for the group identified by the users. Device 400 may contain an interface circuit 420 to couple the user interface 410 with the internal circuitry of the device, such as an internal bus 415 as is known in the art. A processor 425 assists in controlling the various interfaces and resources for the device 400. Those resources include a local memory 435 used for program and/or data storage and well as a network interface 430. The network interface 430 is used to allow the device 400 to communicate with the network of interest. For example, the network interface 430 can be a wired or wireless interface for the functionality described for user interface a device to communicate with the recommendation engine 116. Alternately, the network interface of 430 may be an interface first or second control devices to communicate with a smart TV, which include various functionalities for communicating with a network built in. Such an interface may be acoustic, RF, infrared, or wired. Alternately, the network interface 430 may be an external network interface device such as a router or modem.

Other alternative user device type or configuration can be well understood by those of skill in the art. For example, if the user device associated with a user of FIG. 1 is a digital television, then the architecture of the user device would be that of a digital television or monitor which can display a recommendations list or which can render or display the recommendation items themselves to the users.

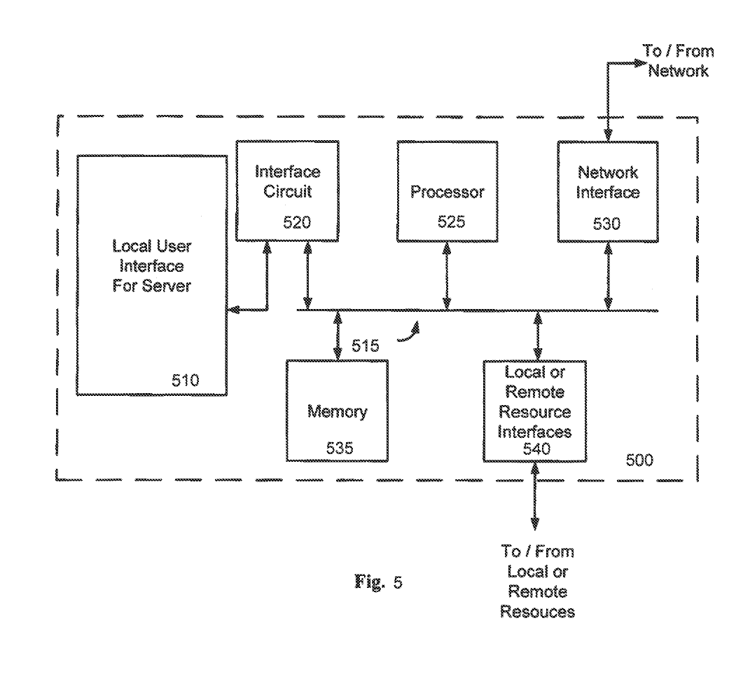

FIG. 5 is a depiction of a server which can form the basis of a recommendation engine. As expressed above, the recommendation engine may be typically be placed in such stand alone such as a smart TV, modem, router, or set top box or the like. Alternatively, the recommendation engine may be placed in a facility associated with the content provider and be connected to the plurality of users through the internet. The server or recommendation engine may have a local user or administrator interface 510 which is coupled to an interface circuit 520 which may provide interconnection to an optional bus 515. Any such interconnection may include a processor 525, local memory 535, a network interface 530, and optional local or remote resource interconnection interfaces 540.

The processor 525 performs control functions for the recommendation engine or server as well as providing the computation resources for determination of the recommendation list provided to the users of the recommendation engine. For example, the stochastic bandits with side observation algorithm may be processed by processor 525 using program and data resources 535. Note that the processor 525 may be a single processor or multiple processors, either local to server 500 or distributed via interfaces 530 and/or 540. Processing of the algorithm requires access to the user data inputs acquired via a user interface device, such as that in FIG. 5, and use of a recommendations items database such as that shown in FIG. 1. Network interface 530 may be used for primary communication in a network, such as a connection to an Internet, cell phone, or other private or public external network to allow access to the server 500 by the supporting external network. For example, network interface 530 may be used for primary communication between the user devices and the recommendation engine to receive requests and feedback from users and to provide recommendations to groups of users. Network interface may also be used to collect information regarding potential items for recommendations stored in a database if such a database is located on the supporting external network. However, if such resources such as parallel computing engines, memory, or a database of recommendation items is located either on a different network than that if interface 530 or an a local network, then interface 540 may be used to communicate with that local or remote network. Interface 540 provides an alternative or a supplemental network interface to network interface 530. It is to be noted that server 500 may be located on an identifiable network as a distinct entity or may be distributed to accommodate cloud computing.

Although specific architectures are shown for the implementation of a user device in FIG. 4 and a server in FIG. 5, one of skill in the art will recognize that implementation options exist such as distributed functionality of components, consolidation of components, and use of internal busses or not. Such options are equivalent to the functionality and structure of the depicted and described arrangements.

Other aspects of the invention, including a further background on the scope of application of the invention and the stochastic bandit with side observation are described in detail below.

The implementations described herein may be implemented in, for example, a method or process, an apparatus, or a combination of hardware and software. Even if only discussed in the context of a single form of implementation (for example, discussed only as a method), the implementation of features discussed may also be implemented in other forms (for example, a hardware apparatus, hardware and software apparatus, or a computer-readable media). An apparatus may be implemented in, for example, appropriate hardware, software, and firmware. The methods may be implemented in, for example, an apparatus such as, for example, a processor, which refers to any processing device, including, for example, a computer, a microprocessor, an integrated circuit, or a programmable logic device. Processing devices also include communication devices, such as, for example, computers, cell phones, portable/personal digital assistants (“PDAs”), and other devices that facilitate communication of information between end-users.

Additionally, the methods may be implemented by instructions being performed by a processor, and such instructions may be stored on a processor or computer-readable media such as, for example, an integrated circuit, a software carrier or other storage device such as, for example, a hard disk, a compact diskette, a random access memory (“RAM”), a read-only memory (“ROM”) or any other magnetic, optical, or solid state media. The instructions may form an application program tangibly embodied on a computer-readable medium such as any of the media listed above. As should be clear, a processor may include, as part of the processor unit, a computer-readable media having, for example, instructions for carrying out a process. The instructions, corresponding to the method of the present invention, when executed, can transform a general purpose computer into a specific machine that performs the methods of the present invention.

The present principles consider stochastic bandits with side observations, a model that accounts for both the exploration/exploitation dilemma and relationships between arms. In this setting, after pulling an arm i, the decision maker also observes the rewards for some other actions related to i. We will see that this model is suited to content recommendation in social networks, where users' reactions may be endorsed or not by their friends. We provide efficient methodologies based on upper confidence bounds (UCBs) to leverage this additional information and derive new bounds improving on standard regret guarantees. We also evaluate these policies in the context of movie recommendation in social networks: experiments on real datasets show substantial learning rate speedups ranging from 2.2× to 14× on dense networks.

In the classical stochastic multi-armed bandit problem, a decision maker repeatedly chooses among a finite set of K actions. At each time step t, the action i chosen yields a random reward X_{i,t} drawn from a probability distribution proper to action i and unknown to the decision maker. Her goal is to maximize her cumulative expected reward over the sequence of chosen actions. This problem has received well-deserved attention from the online learning community for the simple model it provides of a tradeoff between exploration (trying out all actions) and exploitation (selecting the best action so far). It has several applications, including content recommendation, Internet advertising and clinical trials.

The decision maker's performance after n steps is typically measured in terms of the regret R(n), defined as the difference between the reward of her strategy and that of an optimal strategy (one that would always choose actions with maximum expected reward). One of the most prominent algorithms in the stochastic bandit literature, UCB1 from Auer et al., achieves a logarithmic (expected) regret

[symbol]

[R(n)]≦A_{UCB1} ln n+B_{UCB1}, (1)

where A_{UCB1} and B_{UCB1} are two constants specific to the policy. This upper bound implies fast convergence to an optimal policy: the mean loss per decision after n rounds is only [symbol] [R(n)/n]=O(ln n/n) in expectation (which scaling is known to be optimal).

This paper considers the stochastic bandit problem with side observations (a setting that has been previously considered but for adversarial bandits, see below, a generalization of the standard multi-armed bandit where playing an action i at step t not only results in the reward X_{i,t}, but also yields information on some related actions {X_{j,t}}. We also present a direct application of this scenario is advertising in social networks: a content provider may target users with promotions (e.g., “20% off if you buy this movie and post it on your wall”), get a reward if the user reacts positively, but also observe her connections' feelings toward the content (e.g., friends reacting by “Liking” it or not).

Notable features of the present principles are as follows. First, we consider a generalization UCB-N of UCB1 taking side observations into account. We show that its regret can be upper bounded as in (1) with a smaller A_{UCB-N}<A_{UCB1}. Then, we provide a better methodology UCB-MaxN achieving an improved constant term B_{UCB-MaxN}<B_{UCB-N}. We show that both improvements are significant for bandits with a large number of arms and a dense reward structure, as is for example the case of advertising in social networks. We finally evaluate our policies on real social network datasets and observe substantial learning rate speedups (from 2.2× to 14×).

Multi-armed bandit problems became popular with the seminal paper of Robbins in 1952. Thirty years later, Lai and Robbins provided one of the key results in this literature when they showed that, asymptotically, the expected regret for the stochastic problem has to grow at least logarithmically in the number of steps, i.e.,

[symbol]

[R(n)]=Ω(ln n).

They also introduced an algorithm that follows the “optimism in the face of uncertainty” principle and decides which arm to play based on upper confidence bounds (UCBs). Their solution asymptotically matches the logarithmic lower bound.

More recently, Auer et al. considered the case of bandits with bounded rewards and introduced the well-known UCB1 policy, a concise strategy achieving the optimal logarithmic bound uniformly over time instead of asymptotically. Further work improved the constants A_{UCB1} and B_{UCB1} in their upper bound (1) using additional statistical assumptions [3].

One of the major limitations of standard bandit algorithms appears in situations where the number of arms K is large or potentially infinite; note for instance that the upper bound (1) scales linearly with K. One approach to overcome this difficulty is to add structure to the rewards distributions by embedding arms in a metric space and assuming that close arms share a similar reward process. This is for example the case in dependent bandits [19], where arms with close expected rewards are clustered.

X-armed bandits allow for an infinite number of arms x living in a measurable space X. They assume that the mean reward function μ: x [symbol] [symbol] [Xₓ] satisfies some Lipschitz assumptions and extend the bias term in UCBs accordingly. Bubeck et al. provide a tree-based optimization algorithm that achieves, under proper assumptions, a regret independent of the dimension of the space.

Linear bandits are another example of structured bandit problems with infinitely many arms. In this setting, arms x live in a finite-dimensional vector space and mean rewards are modeled as linear functions of a system-wide parameter Zε [symbol] , i.e., [symbol] [Xₓ]=Z·x. Near-optimal policies typically extend the notion of confidence intervals to confidence ellipsoids, estimated through empirical covariance matrices, and use the radius of these confidence regions as the bias term in their UCBs.

This last framework allows for contextual bandits and has been used as such in advertisement and content recommendation settings: to personalized news article recommendation, and extend to generalized linear models¹ and applied it to Internet advertisement. The approach in both these works is to reduce a large number of arms to a small set of numerical features, and then apply a linear bandit policy in the reduced space. Constructing good features is thus a crucial and challenging part of this process. In the present principles, we do not make any assumption on the structure of the reward space. We handle the large number of arms in multi-armed bandits leveraging a phenomenon known as side observations which occurs in a variety of problems. This phenomenon has already been studied by Mannor et al. in the case of adversarial bandits, i.e., where the reward sequence {X_{i,t}} is arbitrary and no statistical assumptions are made. They proposed two algorithms: EXPBAN, a mix of experts and bandits algorithms based on a clique decomposition of the side observations graph, and ELP, an extension of the well-known EXP3 algorithm taking the side observation structure into account. While the clique decomposition in EXPBAN inspired our present work, our setting is that of stochastic bandits: statistical assumptions on the reward process allow us to derive O(ln n) regret bounds, while the best achievable bounds in the adversarial problem are Õ(\sqrt{n}). It is indeed much harder to learn in an adversarial environment, and the methodology to address this family of problems is quite different from the techniques we use in our work. ¹ in which [symbol] [Xₓ]=ƒ(Z·x) for some regular function ƒ

Note that our side observations differ from contextual side information, another generalization of the standard bandit problems where some additional information is given to the decision maker before pulling an arm. Asymptotically optimal policies have been provided for this setting in the case of two-armed bandits.

Formally, a K-armed bandit problem is defined by K distributions [symbol] ₁, . . . , [symbol] _{K}, one for each “arm” of the bandit, with respective means μ₁, . . . , μ_{K}. When the decision maker pulls arm i at time t, she receives a reward X_{i,t}˜ [symbol] ᵢ. All rewards {X_{i,t}, iε1, K, t≧1} are assumed to be independent. We will also assume that all { [symbol] ᵢ} have support in [0,1]. The mean estimate for [symbol] [Xᵢ,•] after m observations is

$${\overline{X}}_{i , m} := \frac{1}{m} {\sum }_{s = 1}^{m} {X}_{i , s} .$$

The (cumulative) regret after n steps is defined by

$$R ( n ) := {\sum }_{t = 1}^{n} {X}_{{i}^{*} , t} - {\sum }_{t = 1}^{n} {X}_{{I}_{t} , t} ,$$

where i*=arg max {μᵢ} and Iₜ is the index of the arm played at time t. The gambler's goal is to minimize the expected regret of the policy, which one can rewrite as

$$𝔼 [ R ( n ) ] = {\sum }_{i = 1}^{K} {Δ}_{i} 𝔼 [ {T}_{i} ( n ) ]$$

where Tᵢ(n):=Σₜ₌₁ⁿ 1{Iₜ=i} denotes the number of times arm i has been pulled up to time n, and Δᵢ:=μ*−μᵢ is the expected loss incurred by playing arm i instead of an optimal arm.

In the standard multi-armed bandit problem, the only information available at time t is the sequence (Xᵢ_{ₛ}_{,s})_{s≦t}. We now present our setting with side observations. The side observation (SO) graph G=(V, E) is an undirected graph over the set of arms V=1, K, where an edge i [symbol] j means that pulling arm i (resp. j) at time t yields a side observation of X_{j,t} (resp. X_{i,t}). Let N(i) denote the observation set of arm i consisting of i and its neighbors in G. Contrary to previous work on UCB algorithms, in our setting the number of observations made so far for arm i at time n is not Tᵢ (n) but

$${O}_{i} ( n ) := {\sum }_{t = 1}^{n} 1 \{ {I}_{t} ∈ N ( i ) \} ,$$

which accounts for the fact that observations come from pulling either the arm or one of its neighbors. Note that Oᵢ (n)≧Tᵢ(n).

A clique in G is a subset of vertices C⊂V such that all arms in C are neighbors with each other. A clique covering [symbol] of G is a set of cliques such that [symbol] C=V. Table 1 summarizes our notations.

TABLE 1
Notations Summary

| | |
|---|---|
| K | # of arms |
| X_{i,t} | reward of arm i at time t |
| μᵢ | mean reward of arm i |
| Δᵢ | expected loss for playing arm i |
| i* | index of an optimal arm |
| μ* | mean reward of arm i* |
| Iₜ | index of the arm played at time t |
| Tᵢ(n) | # pulls to arm i after n steps |
| N(i) | neighborhood of arm i (includes i) |
| Oᵢ(n) | # observations for arm i after n steps |
| O*(n) | same for arm i* |

1. Lower Bound

Before we analyze our policies, let us note that the problem we study is at least as difficult as the standard multi-armed bandit problem in the sense that, even with additional observations, the expected regret for any strategy has to grow at least logarithmically in the number of rounds. The only exception to this would be a graph where every node is neighbor with an optimal arm, a particular and easier setting that we do not study here. This observation is stated by the following Theorem:

Theorem 1.

Let B*:=arg max {μᵢ|iεV} and suppose ∪_{iεB*}, N(i)≠V. Then, for any uniformly good allocation rule,² [symbol] [R(n)]=Ω(ln n). ²i.e., not depending on the labels of the arms, see [13]

Proof.

For a set of arms S, we denote N(S):=∪_{jεS} N(j). Let i*εB* and ν:=arg max {μⱼ|jεV\N(B*)}, i.e., the best arm which cannot be observed by pulling an optimal arm.

First assume that N(ν)∩N(B*)=Ø. The proof follows by comparing the initial bandit problem with side observations denoted [symbol] with the two-armed bandit [symbol] without side observations where the reward distributions are [symbol] * for the optimal arm 1 and [symbol] _{ν} for the non-optimal arm 2. To any strategy for [symbol] , we associate the following strategy for [symbol] : if arm i is played in [symbol] at time t, play in [symbol] : arm 1 if iεN(B*) and get reward X_{i*,t}; arm 2 if iεN(ν) and get reward X_{ν,t}; no arm otherwise.

Let n′ denote the number of arms pulled in [symbol] after n steps in [symbol] . It is clear that n′≦n and a valid strategy for [symbol] gives a valid strategy for [symbol] . The expected regret incurred by arm 1 in [symbol] is 0, and each time arm 2 is pulled in [symbol] , a sub-optimal arm is pulled in [symbol] with larger expected loss. As a consequence, [symbol] [R [symbol] (n)]≧ [symbol] [R [symbol] (n′)], where R [symbol] (resp. R [symbol] ) denotes the regret in [symbol] (resp. [symbol] ). By the classical result of Lai and Robbins, [symbol] [R [symbol] (n′)]=Ω(ln n′). Hence, if n′=Ω(n) the claim follows. If n′=o(n), then sub-optimal arms are played in [symbol] at least n−n′ times so that [symbol] [R [symbol] (n)]=Ømega(n−n′)=Ω(n) and the claim follows as well.

Now assume that N(ν)∩N(B*)≠Ø. A valid strategy for [symbol] does not give a valid strategy for [symbol] any more, since pulling an arm in N(ν)∩N(B*) gives information on both an optimal arm and ν, i.e., both arms in [symbol] . We need to modify slightly the two-armed bandit as follows. First, we define u:=arg max {μᵢ|iεN(ν)∩N(B*)} and w:=ν if μ_{ν}≧μᵤ and u otherwise. The reward distribution for arm 2 in [symbol] is now [symbol] _{w}. To any strategy for [symbol] , we associate a strategy for [symbol] as follows: when arm i is played in [symbol] at time t, play in [symbol] :
iεN(B*)\N(ν) [symbol] pull arm 1, get reward X_{i*,t};
iεN(ν)\N(B*) [symbol] pull arm 2, get reward X_{w,t};
iεN(ν)∩N(B*) [symbol] pull arms 1 and 2 in two consecutive steps, getting rewards X_{i*,t} and X_{w,t};
otherwise, do not pull any arm.

Let n′ denote the number of arms pulled in [symbol] after n steps in [symbol] . We now see that any valid strategy for [symbol] gives a valid strategy for [symbol] . As in previous setting, the expected regret incurred by arm 1 in [symbol] is 0, and each time arm 2 is pulled in [symbol] , a sub-optimal arm is pulled in [symbol] with larger expected loss. As a consequence, [symbol] [R [symbol] (n)]≧ [symbol] [R [symbol] (n′)], and we can conclude as above. □

2. Upper Confidence Bounds

The UCB1 policy constructs an Upper Confidence Bound for each arm i at time t by adding a bias term \sqrt{2 ln t/Tᵢ(t−1)} to its sample mean. Hence, the UCB for arm i at time t is

$${UCB}_{i} ( t ) := {\overline{X}}_{i , {T}_{i} ( t - 1 )} + \sqrt{\frac{2 ln t}{{T}_{i} ( t - 1 )}} .$$

Auer et al. have proven that the policy which picks arg maxᵢ UCBᵢ (t) at every step t achieves the following upper bound after n steps:

$$𝔼 [ R ( n ) ] \leq 8 ( {\sum }_{i = 1}^{K} \frac{1}{{Δ}_{i}} ) ln n + ( 1 + \frac{{π}^{2}}{3} ) {\sum }_{i = 1}^{K} {Δ}_{i} . \qquad ( 2 )$$

In the setting with side observations, we will show in Section 3 that a generalization of this policy yields the (improved) upper bound

$$𝔼 [ R ( n ) ] \leq 8 ( {inf}_{𝒞} {\sum }_{C ∈ 𝒞} \frac{{max}_{i ∈ C} {Δ}_{i}}{{min}_{i ∈ C} {Δ}_{i}^{2}} ) ln n + O ( K ) ,$$

where the O(K) term is the same as in (2), and the infimum is over all possible clique coverings of the SO graph. We will detail below how this bound improves on the original Σᵢ 1/Δᵢ.

We will then introduce below a methodology improving on the constant O(K) term (remember that the number of arms K is assumed >>1). By proactively using the underlying structure of the SO graph, we will reduce it to the following finite-time upper bound:

$$( 1 + \frac{{π}^{2}}{3} ) {\sum }_{C ∈ 𝒞} {Δ}_{C} + {O}_{n \to ∞} ( 1 ) ,$$

where Δ_{C} is the best individual regret in clique Cε [symbol] . Note that, while both constant terms were linear in K in Equation (2), our improved factors are both O(| [symbol] |) where | [symbol] | is the number of cliques used to cover the SO graph. We will show that this improvement is significant for dense reward structures, as is the case with advertising in social networks (see Section 5).

3. UCB-N Policy

In the multi-armed bandit problem with side observations, when the decision maker pulls an arm i after t rounds of the game, he/she gets the reward X_{i,t} and observes {X_{j,t}|jεN(i)}. We consider in this section the policy UCB-N where one always plays the arm with maximum UCB, and updates all mean estimates { X̅_{j,t}|jεN(i)} in the observation set of the pulled arm i. In practical terms, the methodology consists of giving a promotion to the person with the highest upper confidence bound, which is indicative of the probability of accepting the offer and the uncertainty of the estimate. The result of giving the promotion is observed as to the feedback from all the neighbors of the person in the social network, and the estimators of the person and the neighbors are estimated. Therefore, the estimators for group of users can be updated based on feedback generated by initially providing the promotion to the selected person. The updated estimators are then used in determining target users for future promotions.

Methodology 1 UCB-N

```
  X̅, O ← 0, 0
  for t ≧ 1 do
    $i ← arg {max}_{i} \{ {\overline{X}}_{i} + \sqrt{\frac{2 ln t}{{o}_{i}}} \}$
    pull arm i
    for k ε N(i) do
      Oₖ ← Oₖ + 1
      X̅ₖ ← X_{k,t}/Oₖ + (1 − 1/Oₖ) X̅ₖ
    end for
end for
```

We take the convention \sqrt{1/0}=+∞ so that all arms get observed at least once. This strategy takes all the side information into account to improve the learning rate. The following Theorem quantifies this improvement as a reduction in the logarithmic factor from Equation (2).

Theorem 2.

The expected regret of policy UCB-N after n steps is upper bounded by

$$𝔼 [ R ( n ) ] \leq {inf}_{𝒞} \{ 8 ( {\sum }_{C ∈ 𝒞} \frac{{max}_{i ∈ C} {Δ}_{i}}{{Δ}_{C}^{2}} ) ln n \} + ( 1 + \frac{{π}^{2}}{3} ) {\sum }_{i = 1}^{K} {Δ}_{i} ,$$

where Δ_{C}=min_{iεC}Δᵢ.

Proof.

Consider a clique covering [symbol] of G=(V,E), i.e., a set of subgraphs such that each Cε [symbol] is a clique and V=∪_{Cε} [symbol] C. One can define the intra-clique regret R_{C}(n) for any Cε [symbol] by

$${R}_{C} ( n ) := {\sum }_{t < n} {\sum }_{i ∈ C} {Δ}_{i} 1 \{ {I}_{t} = i \} .$$

Since the set of cliques covers the whole graph, we have R(n)≦Σ_{Cε} [symbol] R_{C}(n). From now on, we will focus on upper bounding the intra-clique regret for a given clique Cε [symbol] .

Let T_{C} (t):=Σ_{iεC} Tᵢ(t) denote the number of times (any arm in) clique C has been played up to time t. Then, for any positive integer l_{C},

$${R}_{c} ( n ) \leq {𝓁}_{c} {max}_{i ∈ c} {Δ}_{i} + {\sum }_{{i ∈ c}_{t \leq n}} {Δ}_{i} 1 \{ {I}_{t} = i ; {T}_{c} ( t - 1 ) \geq {𝓁}_{c} \}$$

Considering that the event {lₜ=i} implies { X̅_{i,O}_{ᵢ}₍ₜ₋₁₎+c_{t-1,O}_{ᵢ}₍ₜ₋₁₎≧ X̅*_{O*(t-1)}+c_{t-1,O*(t-1)}}, we can upper bound this last summation by:

$${\sum }_{{i ∈ c}_{t < n}} {Δ}_{i} 1 \{ \begin{matrix}{\overline{X}}_{i , {O}_{i} ( t )} + {c}_{t , {O}_{i} ( t )} \geq {\overline{X}}_{{O}^{*} ( t )}^{*} + {c}_{t , {O}^{*} ( t )} \\ {T}_{c} ( t ) \geq {𝓁}_{c}\end{matrix} \} \leq {\sum }_{{i ∈ c}_{t < n}} {Δ}_{i} 1 \{ {max}_{{𝓁}_{c} \leq {s}_{i} \leq t} {\overline{X}}_{i , {s}_{i}} + {c}_{t , {s}_{i}} \geq {min}_{0 \leq s \leq t} {\overline{X}}_{s}^{*} + {c}_{t , s} \} \leq {\sum }_{{i ∈ c}_{t < n}} {\sum }_{s = 0}^{t} {\sum }_{{s}_{i} = {𝓁}_{c}}^{t} {Δ}_{i} 1 \{ {\overline{X}}_{i , {s}_{i}} + {c}_{t , {s}_{i}} \geq {\overline{X}}_{s}^{*} + {c}_{t , s} \}$$

Now, choosing

$${𝓁}_{c} \geq {max}_{i ∈ c} \frac{8 ln n}{{Δ}_{i}^{2}} = \frac{8 ln n}{{min}_{i ∈ c} {Δ}_{i}^{2}} = \frac{8 ln n}{{Δ}_{c}^{2}}$$

will ensure that [symbol] ( X̅_{i,s}_{ᵢ}+c_{t,s}_{ᵢ}≧ X̅*ₛ+c_{t,s})≦2t⁻⁴ for any iεC as a consequence of the Chernoff-Hoeffding bound. Hence, the overall clique regret is bounded by:

$${R}_{c} ( n ) \leq {𝓁}_{c} {max}_{i ∈ c} {Δ}_{i} + {\sum }_{i ∈ c} {\sum }_{t = 1}^{∞} 2 {Δ}_{i} {t}^{- 2} \leq 8 \frac{{max}_{i ∈ c} {Δ}_{i}}{{Δ}_{c}^{2}} ln n + ( 1 + \frac{{π}^{2}}{3} ) {\sum }_{i ∈ c} {Δ}_{i} .$$

Summing over all cliques in [symbol] and taking the infimum over all possible coverings [symbol] yields the aforementioned upper bound. □

When [symbol] is the trivial covering {{i}, iεV}, this upper bound reduces exactly to Equation (2). Therefore, taking side observations into account systematically improves on the baseline UCB1 policy.

4. UCB-MaxN Policy

The second term in the upper bound from Theorem 2 is still linear in the number of arms and may be large when K>>1. In this section, we introduce a new policy that makes further use of the underlying reward observations to improve performances.

Consider the two extreme scenarii that can make an arm i played at time t: it has the highest UCB, so
either its average estimate X̅_{i,t} is very high, which means it is empirically the best arm to play,
or its bias term \sqrt{2 ln t/Oᵢ(t−1)} is very high, which means one wants more information on it.

In the second case, one wants to observe a sample X_{i,t} to reduce the uncertainty on arm i. But in the side observation setting, we don't have to pull this arm directly to get an observation: we may as well pull any of its neighbors, especially one with higher empirical rewards, and reduce the bias term all the same. Meanwhile, in the first case, arm i will already be the best empirical arm in its observation set.

This reasoning motivates the following policy, called UCB-MaxN, where we first pick the arm we want to observe according to UCBs, and then pick in its observation set the arm we want to pull, this time according to its empirical mean only.

Methodology 2 UCB-MaxN

```
  X̅, n ← 0, 0
  for t ≧ 1 do
    $i ← arg {max}_{i} \{ {\overline{X}}_{i} + \sqrt{\frac{2 ln t}{{o}_{i}}} \}$
    $j ← arg {max}_{j ∈ N ( i )} {\overline{X}}_{j}$
    pull arm j
    for k ε N(j) do
      Oₖ ← Oₖ + 1
      X̅ₖ ← X_{k,t}/Oₖ + (1 − 1/Oₖ) X̅ₖ
    end for
end for
```

In practical terms, this methodology consists of giving the promotion to the neighbor of the person with the highest upper confidence bound that has the highest probability of accepting the offer (based on the current estimate). The response to the promotion is observed in terms of the feedback from all the neighbors of the person in the social network, and then the estimators of the persons in the network are updated. The updated estimators can then be used in determining the target users for other promotions.

Asymptotically, UCB-MaxN reduces the second factor in the regret upper bound (2) from O(K) to O(| [symbol] |), where [symbol] is an optimal clique covering of the side observation graph G.

Theorem 3.

The expected regret of strategy UCB-MaxN after n steps is upper bounded by

$$𝔼 [ R ( n ) ] \leq {inf}_{𝒞} \{ 8 ( {\sum }_{c ∈ 𝒞} \frac{{max}_{i ∈ c} {Δ}_{i}}{{Δ}_{c}^{2}} ) ln n + ( 1 + \frac{{π}^{2}}{3} ) {\sum }_{c ∈ 𝒞} {Δ}_{c} \} + {o}_{n \to ∞} \qquad ( 1 )$$

We will make use of the following lemma to prove this theorem:

Lemma 1.

Let X₁, . . . , Xₙ and Y₁, . . . , Yₘ denote two sets of i.i.d. random variables of respective means μ and ν such that μ<ν. Let Δ:=μ−ν. Then,

[symbol]

( X̅ₙ> Y̅ₘ)≦2e^{-min(n,m)Δ}^{²}^{/2}.

Proof.

Note that either X̅ₙ<½(μ+ν)< Y̅ₘ or one of the two events X̅ₙ>½(μ+ν) or Y̅ₘ<½(μ+ν) occurs. As a consequence, the probability [symbol] ( X̅ₙ> Y̅ₘ) is lower than

$$ℙ ( {\overline{X}}_{n} > \frac{μ + v}{2} ) + ℙ ( {\overline{Y}}_{m} < \frac{μ + v}{2} ) \leq ℙ ( {\overline{X}}_{n} - μ > - \frac{Δ}{2} ) + ℙ ( {\overline{Y}}_{m} - v < \frac{Δ}{2} ) \leq {e}^{- n {Δ}^{2} / 2} + {e}^{- m {Δ}^{2} / 2} \leq 2 {e}^{- min ( n , m ) {Δ}^{2} / 2} .$$

Proof of Theorem 3.

Let k_{C}:=arg min_{iεC} Δᵢ denote the best arm in clique C, and define δᵢ:=Δᵢ−Δ_{C} for each arm iεC. As in the beginning of our proof for Theorem 2, we can upper bound:

$${R}_{c} ( n ) \leq {𝓁}_{c} {max}_{i ∈ c} {Δ}_{i} + {\sum }_{{i ∈ c}_{t < n}} {Δ}_{i} 1 \{ {I}_{t} = i ; {T}_{c} ( t - 1 ) \geq {𝓁}_{c} \} \qquad ( 3 )$$

where this last summation is upper bounded by

$${\sum }_{{i ∈ c}_{t < n}} ( {Δ}_{c} + {δ}_{i} ) 1 \{ {I}_{t} = i ; {T}_{c} ( t - 1 ) \geq {𝓁}_{c} \} \leq {\sum }_{t < n} {Δ}_{c} 1 \{ {I}_{t} = {k}_{c} ; {T}_{c} ( t - 1 ) \geq {𝓁}_{c} \} + {\sum }_{{i ∈ c}_{t < n}} {Δ}_{i} 1 \{ {I}_{t} = i ; {T}_{c} ( t - 1 ) \geq {𝓁}_{c} \}$$

The first summation can be bounded using the Chernoff-Hoeffding inequality as before:

$${\sum }_{t < n} 1 \{ {I}_{t} = {k}_{c} ; {T}_{c} ( t - 1 ) \geq {𝓁}_{c} \} \leq {\sum }_{t < n} {\sum }_{{s \leq t}_{{𝓁}_{c} \leq {s}_{k} \leq t}} 1 \{ {\overline{X}}_{{k}_{c} , {s}_{k}} + {c}_{t , {s}_{k}} > {\overline{X}}_{s}^{*} + {c}_{t , s} \} \leq 2 {\sum }_{t < n} {t}^{- 2} \leq 1 + \frac{{π}^{2}}{3}$$

with an appropriate choice of

$${𝓁}_{c} \geq \frac{8 ln n}{{Δ}_{c}^{2}} .$$

As to the second summation, the fact that Algorithm 4 picks i instead of k_{C} at step t implies that X̅_{i,O}_{ᵢ}₍ₜ₎> X̅ₖ_{_{C}}_{,O}_{_{kC}}₍ₜ₎, so

$${R}_{c}^{′} ( n ) := {\sum }_{{i ∈ c}_{t < n}} {Δ}_{i} 1 \{ {I}_{t} = i ; {T}_{c} ( t - 1 ) \geq {𝓁}_{c} \} \leq {\sum }_{{i ∈ c}_{t < n}} {Δ}_{i} 1 \{ \begin{matrix}{\overline{X}}_{i , {O}_{i} ( t - 1 )} > {\overline{X}}_{{k}_{c} , {O}_{{k}_{c}} ( t - 1 )} \\ {T}_{c} ( t - 1 ) \geq {𝓁}_{c}\end{matrix} \}$$

Consider the times l_{C}≦τ₁≦ . . . ≦τ_{T}_{_{C}}₍ₙ₎ when the clique C was played (after the first l_{C} steps). Then, one can rewrite R′_{C}(n) as follows:

$${R}_{c}^{′} ( n ) \leq {\sum }_{u = {𝓁}_{c}}^{{T}_{c} ( n )} {\sum }_{i ∈ c} {Δ}_{i} 1 \{ {\overline{X}}_{i , {o}_{i} ( {τ}_{u} )} > {\overline{X}}_{{k}_{c} , {o}_{{k}_{c}} ( {τ}_{u} )} \}$$

$$𝔼 [ {( {R}^{′} )}_{c} ( n ) ] \leq {\sum }_{u = {𝓁}_{c}}^{{T}_{c} ( n )} {\sum }_{i ∈ c} {Δ}_{i} ℙ ( {\overline{X}}_{i , {o}_{i} ( {τ}_{u} )} > {\overline{X}}_{{k}_{c} , {o}_{{k}_{c}} ( {τ}_{u} )} )$$

After the clique C has been played u times, all arms in C being neighbors in the side observation graph, we know that each estimate X̅ᵢ, iεC has at least u samples, i.e., Oᵢ(τᵤ)≧u. Therefore, using Lemma 1 with “n=Oᵢ(τᵤ)” and “m=Oₖ_{_{C}}(τᵤ)” in the previous expression yields

$$𝔼 [ {R}_{c}^{′} ( n ) ] \leq {\sum }_{i ∈ c} {\sum }_{u = {𝓁}_{c}}^{{T}_{c} ( n )} 2 {Δ}_{i} {e}^{- u {δ}_{i}^{2} / 2} \leq 2 {\sum }_{{i ∈ c}_{{δ}_{i} > 0}} {Δ}_{i} \frac{1 - {e}^{- n {δ}_{i}^{2} / 2}}{1 - {e}^{- {δ}_{i}^{2} / 2}} {e}^{- {𝓁}_{c} {δ}_{i}^{2} / 2} ,$$

where δᵢ=μᵢ−min_{jεC}μⱼ. Combining all these separate upper bounds in Equation (3) leads us to

$$𝔼 [ {R}_{c} ( n ) ] \leq 8 \frac{{max}_{i ∈ c} {Δ}_{i}}{{Δ}_{c}^{2}} ln n + ( 1 + \frac{{π}^{2}}{3} ) {Δ}_{c} + 2 {\sum }_{{i ∈ c}_{{δ}_{i} > 0}} {Δ}_{i} \frac{1 - {e}^{- n {δ}_{i}^{2} / 2}}{1 - {e}^{- {δ}_{i}^{2} / 2}} \cdot {( \frac{1}{n} )}^{4 {δ}_{1}^{2} / {Δ}_{c}^{2}}$$

where this last term is o_{n→∞}(1). □

UCB-MaxN is asymptotically better than UCB-N: again, its upper bound expression boils down to Equation (2) when applied to the trivial covering [symbol] ={{i}, iεV}.

Note that our bound is achieved uniformly over time and not only asymptotically; we only used the o(1) notation in Theorem 3 to highlight that the last term vanishes when n→∞. This term may actually be large for small values of n and pathological regret distributions, e.g., if some δᵢ are such that δᵢ<<Δ_{C}. However, with distributions drawn from real datasets we observed a fast decrease: in the Flixster experiment for instance, this term was below the (1+π²/3)Δ_{C} constant for more than 80% of the cliques after T˜20K steps.

We have seen so far that our policies improve regret bounds compared to standard UCB strategies. Let us evaluate how these methodologies perform on real social network datasets. In this section, we perform three experiments. First, we evaluate the UCB-N and UCB-MaxN policies on a movie recommendation problem using a dataset from Flixster [2]. The policies are compared to three baseline solutions: two UCB variants with no side observations, and an ε-greedy with side observations. Second, we investigate the impact of extending side observations to friends-of-friends, a setting inspired from average user preferences on social networks that densifies the reward structure and speeds up learning. Finally, we apply the UCB-N and N algorithms in a bigger social network setup with a dataset from Facebook [1].

We perform empirical evaluation of our algorithms on datasets from two social networks: Flixster and Facebook. Flixster is a social networking service in which users can rate movies. This social network was crawled by Jamali et al., yielding a dataset with 1M users, 14M friendship relations, and 8.2M movie ratings that range from 0.5 to 5 stars. We clustered the graph using Graclus and obtained a strongly connected subgraph. Furthermore, we eliminated users that rated less than 30 movies and movies rated by less than 30 users. This preprocessing step helps us to learn more stable movie-rating profiles. The resulting dataset involves 5K users, 5K movies, and 1.7M ratings. The subgraph from Facebook we used was collected by Viswanath et al. from the New Orleans region. It contains 60K users and 1.5M friendship relationships. Again, we clustered the graph using Graclus and obtained a strongly connected subgraph of 14K users and 500K edges.

We evaluate our policies in the context of movie recommendation in social networks. The problem is set up as a repetitive game. At each turn, a new movie is sampled from a homogeneous movie database and the policy offers it at a promotional price to one user in the social network.³ If the user rates the movie higher than 3.5 stars, we assume that he/she accepts the promotion and our reward is 1, otherwise the reward is 0. The promotion is then posted on the user's wall and we assume that all friends of that user express their opinion, i.e., whether they would accept a similar offer (e.g., on Facebook by “Liking” or not the promotional message). The goal is to learn a policy that gives promotions to people who are likely to accept them. ³In accordance with the bandit framework, we further assume that the same movie is never sampled twice.

We use standard matrix factorization techniques to predict users ratings from the Flixster dataset. Since the Facebook dataset does not contain movie ratings, we generated rating profiles by matching users between the Flixster and Facebook social networks. This matching is based on structural features only, such as vertex degree, the aim of this experiment being to evaluate the performances of our policies in a bigger network with similar rating distributions across vertices.

The upper bounds we derived in the analysis of UCB-N and UCB-MaxN (Theorems 2 and 3) involve the number of cliques used to cover the side observation graph; meanwhile, bigger cliques imply more observations per step, and thus a faster convergence of estimators. These observations suggest that the minimum number of cliques required to cover the graph impacts the performances of our allocation schemes, which is why we took this factor into account in our evaluation.

Unfortunately, finding a cover with the minimum number of cliques is an NP-hard problem. We addressed it suboptimally as follows. First, for each vertex i in the graph, we computed a maximal clique Cᵢ involving i. Second, a covering using {Cᵢ is found using a greedy algorithm for the SET COVER problem.

For each experiment, we evaluate our policies on 3 subgraphs of the social network obtained by terminating the greedy algorithm after 3%, 15%, and 100% of the graph have been covered. This choice is motivated by the following observation: the degree distribution in social networks is heavy-tailed, and the number of cliques needed to cover the whole graph tends to be on the same scale of order as the number of vertices; meanwhile, the most active regions of the network (which are of practical interest in our content recommendation scenario) are densest and thus easier to cover with cliques. Since the greedy algorithm follows a biggest-cliques-first heuristic, looking at these 3% and 15% covers allows us to focus on these densest regions.

The quality of all policies is evaluated by the per-step regret

$$r ( n ) := \frac{1}{n} 𝔼 [ R ( n ) ] .$$

We also computed for each plot the improvement of each policy against UCB1 after the last round T (a k×improvement means that r(T)≈r_{UCB1}(T)/k). This number can be viewed as a speedup in the convergence to the optimal arm. Finally, all plots include a vertical line indicating the number of cliques in the cover, which is also the number of steps needed by any policy to pull every arm at least once. Before that line, all policies perform approximately the same.

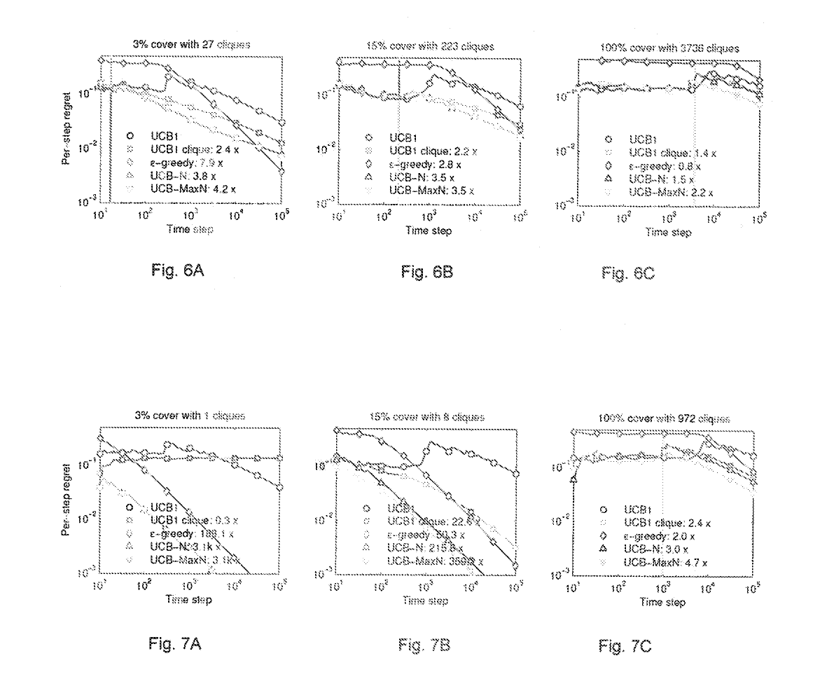

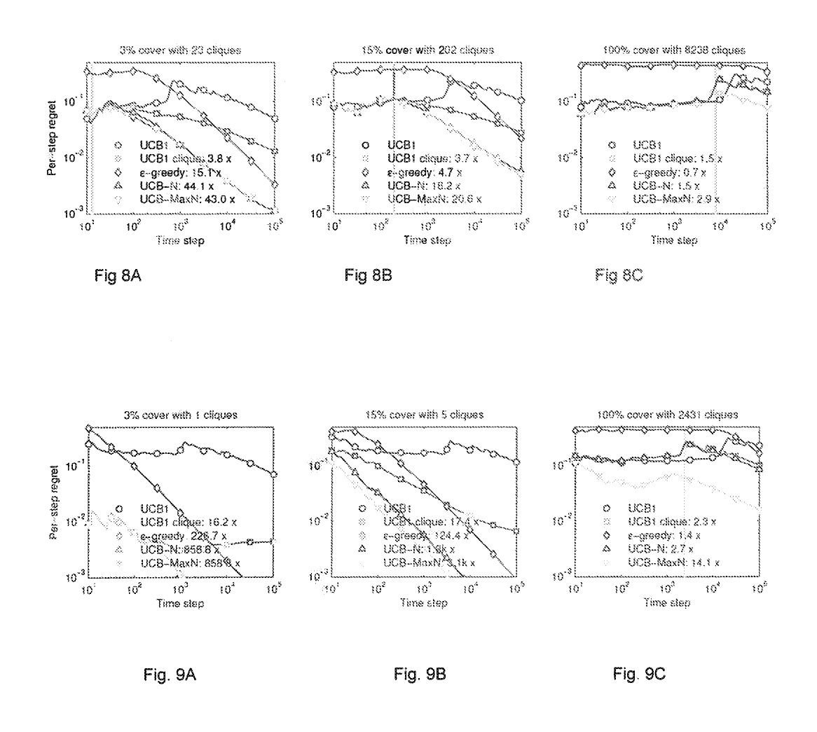

In this first experiment, we evaluate UCB-N and UCB-MaxN in the Flixster social network. These policies are compared to three baselines: UCB1 with no side observation, UCB1-on-cliques and ε-greedy. Our ε-greedy is the same as \check{a}repsilonₙ-greedy in with c=5, d=1 and K=| [symbol] |, which turned out to be the best empirical parametrization within our experiments. UCB1-on-cliques is similar to UCB-N, except that it updates the estimators { X̅ₖ|kεN(i)} with the reward X_{i,t} of the pulled arm i. This is a simple approach to make use of the network structure without access to side observations. As illustrated in FIGS. 6-9, we observe the following trends.

The regret of UCB-N and UCB-Max N is significantly smaller than the regret of UCB1 and UCB1-on-cliques, which suggests these strategies successfully benefit from side observations to improve their learning rate. ε-greedy shows improvement as well, but its performances decrease rapidly as the size of the cover grows (i.e., adding smaller cliques) compared to our strategies. Overall, the performance of all policies deteriorates with more coverage, which is consistent with the O(K) and O(| [symbol] |) upper bounds on their regrets.

UCB-MaxN does not perform significantly better than UCB-N when the size of the cover | [symbol] | is small. This can be explained based on the amount of overlap between the cliques in the cover. In practice, we observed that UCB-MaxN performs better when individual arms belong to many cliques on average. For our 3%, 15%, and 100% graph cover simulations, the average number of cliques covering an arm were 1.18, 1.09, 1.76; meanwhile, the regrets of UCB-MaxN were 9%, 3%, and 33% smaller than the regrets of UCB-N, respectively.

In the second experiment we use a denser graph where side observations come from friends and friends of friends. This setting is motivated by the observation that a majority of social network users do not restrict content sharing to their friends. For instance, more than 50% of Facebook users share all their content items with friends of friends.

FIGS. 6-9 show that the gap between the baselines and our policies is even wider in this new setting. This phenomenon can be explained by larger cliques; for instance, only 8 cliques are needed to cover 15% of the graph in this instance, which is 20 times less than in Section 3.

In the next experiment, we evaluate UCB-N and UCB-Max N on a subset of the Facebook social network. This graph has three times as many vertices and twice as many edges as the Flixster graph. We experiment with both friends and friends-of-friends side observations.

As shown in the FIGS. 6-9, we observe much smaller regrets in this setting, essentially because the Facebook graph is denser. For instance, only 5 friend-of-friend cliques are needed to cover 15% of the graph. For this cover, the regret of UCB-MaxN is 10 times smaller than the regret of UCB1-on-cliques and UCB-N, respectively.

In the present principles, we considered the stochastic multi-armed bandit problem with side observations. This problem generalizes the standard, independent multi-armed bandit, and has a broad set of applications including Internet advertisement and content recommendation systems. Notable features of the present principles consist in two new strategies, UCB-N and UCB-Max N, that leverage this additional information into substantial learning rate speed-ups.

We showed that our policies reduce regret bounds from O(K) to O(| [symbol] |), which is a significant improvement for dense reward-dependency structures. We also evaluated their performances on real datasets in the context of movie recommendation in social networks. Our experiments suggest that these strategies significantly improve the learning rate when the side observation graph is a dense social network.

So far we have focused on cliques as a convenient way to analyze our policies, but none of our two strategies explicitly relies on cliques (they only use the notion of neighborhood). Characterizing the most appropriate subgraph structure for this problem is still an open question that could lead to better regret bounds and inspire more efficient policies.

1. A method for computer generating a recommendation item for one or more users of a plurality of users interconnected via a computerized social network, comprising:
accessing an estimate parameter associated with each of the users, each estimate parameter being indicative of an estimate of probability of accepting an offer and an uncertainty of the estimate for a respective user;
selecting a target user for a particular recommendation;
sending the particular recommendation to the target user via a computer network;
receiving a response indicative of acceptance or rejection of the particular recommendation from the target user;
accessing respective feedback information from users interconnected to the target user via the computerized social network; and
updating respective estimate parameters for the target user and the users interconnected to the target user in response to the response and the respective feedback information, and generating an additional recommendation item for an additional target user based on the updated respective estimate parameters.

2. The method according to claim 1, wherein the target user is a user having a highest estimate parameter for the particular recommendation.

3. The method according to claim 1, wherein the target user is a neighbor of a user having a highest estimate parameter of the particular recommendation.

4. The method according to claim 3, wherein the neighbor has a highest estimate parameter of all neighbors connected to the user.

5. The method according to any of claims 1, wherein the target user comprises a plurality of users who have estimate parameters that exceed a predetermined level.

6. The method according to one of claims 1, wherein the recommendation item comprises a discount coupon, an advertising offer, and multi-media program recommendation.

7. A method for computer generating a recommendation item for one or more users of a plurality of users interconnected via a computerized social network, comprising:
generating a recommendation item related to purchase of a multi-media program;
selecting a target user from a plurality of users connected via a computerized social network;
sending the recommendation item to the target user via a computer network;
receiving, via the computer network, a response indicative of acceptance or rejection of the recommendation item from the target user;
accessing feedback information from ones of the plurality of users connected to the target user;
updating respective estimate parameters associated with each of the plurality of users based on the response and the feedback information, each estimate parameter being indicative of an estimate of probability of accepting an offer and an uncertainty of the estimate for a respective user, and generating additional recommendation items for additional target users based on the updated respective estimate parameters.

8. The method according to claim 7, wherein the target user is a user having a highest estimate parameter for the particular recommendation.

9. The method according to claim 7, wherein the target user is a neighbor of a user having a highest estimate parameter of the particular recommendation.

10. The method according to claim 9, wherein the neighbor has a highest estimate parameter of all neighbors connected to the user.

11. The method according to any of claims 7, wherein the target user comprises a plurality of users who have estimate parameter that exceed a predetermined level.

12. A method for computer generating a recommendation item for one or more users of a plurality of users interconnected via a computerized social network, comprising:
accessing an estimate parameter associated with each of the users, each estimate parameter corresponding to an upper confidence bound parameter in multi-armed bandit model and being indicative of an estimate of probability of accepting an offer and an uncertainty of the estimate for a respective user;
selecting a target user for a particular recommendation;
sending the particular recommendation to the target user via a computer network;
receiving a response indicative of acceptance or rejection of the particular recommendation from the target user;
accessing respective feedback information from users interconnected to the target user via the computerized social network; and
updating respective estimate parameters for the target user and the users interconnected to the target user in response to the response and the respective feedback information, and generating an additional recommendation item for an additional target user based on the updated respective estimate parameters.

13. The method according to claim 12, wherein the target user is a user having a highest estimate parameter for the particular recommendation.

14. The method according to claim 12, wherein the target user is a neighbor of a user having a highest estimate parameter of the particular recommendation.

15. The method according to claim 14, wherein the neighbor has a highest estimate parameter of all neighbors connected to the user.

16. The method according to any of claims 12, wherein the target user comprises a plurality of users who have estimate parameters that exceed a predetermined level.

17. The method according to one of claims 12, wherein the recommendation item comprises a discount coupon, an advertising offer, and multi-media program recommendation.

18. A computerized system for a recommendation item for one or more users of a plurality of users interconnected via a computerized social network, comprising:
a database including an estimate parameter associated with each of the users, each estimate parameter being indicative of an estimate of probability of accepting an offer and an uncertainty of the estimate for a respective user;
a processor configured to select a target user for a particular recommendation; and
communications module configured to send the particular recommendation to the target user via a computer network, and receive a response indicative of acceptance or rejection of the particular recommendation from the target user;
the processor being configured to access respective feedback information from users interconnected to the target user via the computerized social network; and update respective estimate parameters for the target user and the users interconnected to the target user in response to the response and the respective feedback information, and generate an additional recommendation item for an additional target user based on the updated respective estimate parameters.

19. The system according to claim 18, wherein the target user is a user having a highest estimate parameter for the particular recommendation.

20. The system according to claim 18, wherein the target user is a neighbor of a user having a highest estimate parameter of the particular recommendation.

21. The system according to claim 20, wherein the neighbor has a highest estimate parameter of all neighbors connected to the user.

22. The system according to any of claims 18, wherein the target user comprises a plurality of users who have estimate parameters that exceed a predetermined level.

23. The method according to one of claims 18, wherein the recommendation item comprises a discount coupon, an advertising offer, and multi-media program recommendation.
